(19) United States
(12) Patent Application Publication
(10) Pub. No.: US 2014/0065973 A1
(43) Pub. Date: Mar. 6, 2014

(54) APPARATUS AND METHOD FOR AN INDIRECT CONNECT

(71) Applicant: Robert J. Gerichten, St. James, MO (US)

(72) Inventor: Robert J. Gerichten, St. James, MO (US)

(21) Appl. No.: 13/948,124

(22) Filed: Jul. 22, 2013

Related U.S. Application Data
(60) Provisional application No. 61/674,344, filed on Jul. 22, 2012.

(51) Int. Cl. H04B 7/26

(52) U.S. Cl. CPC H04B 7/26
USPC 455/41.3; 455/41.2

(57) ABSTRACT

In one embodiment of the invention, an apparatus includes: a first InDirect connect module configured for removable attachment to a first consumer electronic device, and a second InDirect connect module configured for removable attachment to a second consumer electronic device, the first InDirect connect module including a first wireless processing system for transmitting a signal and the second InDirect connect module including a second wireless processing system for receiving the signal.

### CROSS-REFERENCE TO RELATED APPLICATIONS

This application claims priority to and the benefit of U.S. Provisional Application No. 61/674,344. U.S. Application No. 61/674,344 is hereby fully incorporated herein by reference.

### TECHNICAL FIELD

Embodiments of the invention relate generally to an apparatus and method for an InDirect connect.

### BACKGROUND

Consumer electronic devices such as, for example, televisions, stereo devices, DVD and/or DVR players, computers, other multi-media devices, other home entertainment devices, communication devices, and/or other electronic devices require multiple cords to transmit audio and video signals between these devices. The multiple cords are cumbersome, are often confusing to the user, and can present a mess or an unsightly view in a room. Additionally, these cords occupy unnecessary space.

Moreover, the presence of multiple cords can present a potential hazard to infants, children, and/or pets in the home. Furthermore, chords are of limited length, and therefore, these chords may not be able to electronically connect two electronic devices that are spaced from each other larger distances in a room or in a house.

With technological advances in electronic devices, a consumer can now position televisions, other entertainment devices, and/or other electronic devices in various areas within a room. However, interconnecting technology and relay technology has simply not been able to keep pace with the technological advances in consumer electronic devices. Various wireless audio and video wireless transmission systems are known to those skilled in the art (see, e.g., the wireless transmission system disclosed in U.S. Patent Application Publication No. 20110286717 A1). Commercially available products for wirelessly transmitting cable or satellite television signals include, for example, wireless cable TV extenders from various manufacturers such as AlTech International Corporation (Sunnyvale, Calif.) and RF-Link™ (Corona, Calif.), wireless TV/AV extenders from various manufacturers such as RF-Link, and HS wireless extenders (HDMI) from various manufacturers such as RF-Link and Actiontec© (Sunnyvale, Calif.). However, there is a continuing need to provide wireless systems that are less complicated and more economical for consumers. Therefore, there is an important need to provide a safer, less confusing, more economical, more convenient, and/o visually presentable configuration that electronically connects and/or that permits communications between consumer electronic devices.

Based on at least the above discussion, the current technology is limited in its capabilities and suffers from at least the above constraints and deficiencies.

### SUMMARY

In one embodiment of the invention, an apparatus for an InDirect connect includes: a first InDirect connect module configured for removable attachment to a first consumer electronic device, and a second InDirect connect module configured for removable attachment to a second consumer electronic device, the first InDirect connect module including a first wireless processing system for transmitting a first signal and the second InDirect connect module including a second wireless processing system for receiving the first signal.

In another of the invention, an apparatus for an InDirect connect includes: a first InDirect connect means for removable attachment to a first consumer electronic device, and a second InDirect connect means for removable attachment to a second consumer electronic device, the first InDirect connect means including a first wireless processing means for transmitting a first signal and the second InDirect connect means including a second wireless processing means for receiving the first signal.

In yet another embodiment of the invention, a method for an InDirect connect communication includes: providing a first signal in a first consumer electronic device; transmitting the first signal from the first consumer electronic device to a first InDirect connect module that is removably coupled to the first consumer electronic device; transmitting the first signal from the first InDirect connect module to a wireless path; receiving the first signal from the wireless path to a second InDirect connect module; and transmitting the first signal from the second InDirect connect module to a second consumer electronic device that is removably coupled to the second InDirect connect module.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a block diagram of a system (apparatus), in accordance with an embodiment of the invention.

FIG. 2 is a block diagram of a first InDirect connect module and a second InDirect connect module, in accordance with an embodiment of the invention.

FIG. 3 is a block diagram of a first InDirect connect module and a second InDirect connect module, in accordance with another embodiment of the invention.

FIG. 4 is a flow diagram of a method for an InDirect communication, in accordance with an embodiment of the invention.

### DETAILED DESCRIPTION OF PREFERRED EMBODIMENTS

In the description herein, numerous specific details are provided, such as examples of components, materials, parts, structures, and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, structures, and/or the like. In other instances, well-known components, materials, parts, structures, methods, or operations are not shown or described in detail to avoid obscuring aspects of embodiments of the invention. Additionally, the figures are representative in nature and their shapes are not intended to illustrate the precise shape or precise size of any element and are not intended to limit the scope of the invention.

Those skilled in the art will understand that when an element or part in the drawings is referred to as being “on” (or “connected” to or “coupled” to or “attached” to) another element, it can be directly on (or directly attached to) the other element or intervening elements may also be present. Furthermore, relative terms such as “inner”, “outer”, “upper”, “above”, “lower”, “beneath”, “below”, “downward”, “upward”, “toward”, and “away from” and similar terms, may be used herein to describe a relationship of one element relative to another element. It is understood that these terms are intended to encompass different orientations of the device in addition to the orientation depicted in the figures.

Although the terms first, second, and the like may be used herein to describe various elements, components, parts, regions, layers, chambers, and/or sections, these elements, components, parts, regions, layers, chambers, and/or sections should not be limited by these terms. These terms are only used to distinguish one element, component, part, region, layer, chamber, or section from another element, component, part, region, layer, chamber, or section. Thus, a first element, component, part, region, layer, chamber, or section discussed below could be termed a second element, component, part, region, layer, chamber, or section without departing from the teachings of the present invention.

Embodiments of the invention are described herein with reference to cross-sectional view illustrations that are schematic illustrations of representative embodiments of the invention. As such, variations from the shapes of the illustrations as a result of, for example, manufacturing techniques and/or tolerances are expected. Embodiments of the invention should not be construed as limited to the particular shapes of the regions, elements, components, parts, layers, chambers, and/or sections illustrated herein but are to include deviations in shapes that result, for example, from manufacturing or particular implementations. For example, an element illustrated or described as square or rectangular may typically have rounded or curved features due to normal manufacturing tolerances or due to a particular implementation. Thus, the elements illustrated in the figures are schematic in nature and their shapes are not intended to illustrate the precise shape of an element of a device and are not intended to limit the scope of the invention.

Based on the discussion of the embodiments of the invention as presented herein, those skilled in the art will realize that the positions and/or configurations of the components in the drawings can be varied in different sizes, different shapes, different positions, and/or different configurations. Therefore, various components shown in the drawings can be placed in other positions that differ from the configuration as shown in the drawings. The components in the drawings are illustrated in non-limiting example positions for purposes of explaining the functionalities of the embodiments of the invention, and these components in the drawings can be configured into other example positions.

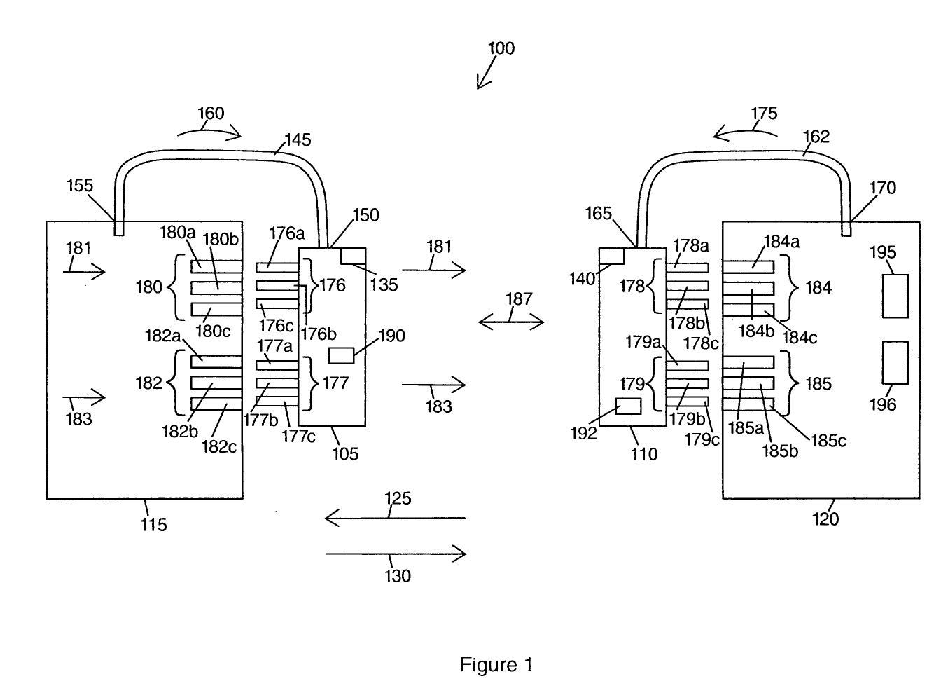

FIG. 1 is a block diagram of an apparatus (system) 100, in accordance with an embodiment of the invention. The apparatus 100 includes a first InDirect connect module 105 that is removably coupled to a first node 115 (first consumer electronic device 115) and a second InDirect connect module 110 that is removably coupled to a second node 120 (second consumer electronic device 110). Two components are removably coupled (or removably attached or removably secured or removably inserted) means that two different components can be attached together or detached apart. Therefore, the first module 105 can be detached or removed from the first node 115 and the second module 110 can be detached or removed from the second node 120.

The first node 115 can be any suitable consumer electronic device such as, by way of example and not by way of limitation, a DVD (Digital Versatile Disc) player, a DVD recorder, a set-top box, or another suitable electronic device. The second node 120 can be any suitable consumer electronic device such as, by way of example and not by way of limitation, a television, a monitor, a projector, a speaker, or another suitable electronic device, or a device that generates a visual output, or a device that generates an audio output, or a device that generates a visual output and an audio output. Typically, the first node 115 and the second node 120 are different types of consumer electronic devices. However, in another example, the first node 115 and the second node 120 may be similar types of consumer electronic devices.

The first InDirect connect module 105 may be removably coupled to the first node 115 by physically moving the first module 105 in the direction 125 which is a direction toward the first node 115. The first InDirect connect module 105 may be detached from the first node 115 by physically moving the first module 105 in the direction 130 which is a direction away from the first node 115 and is a direction opposite to the direction 125.

The second InDirect connect module 110 may be removably coupled to the second node 120 by physically moving the second module 110 in the direction 130 which is a direction toward the second node 120. The second InDirect connect module 110 may be detached from the second node 120 by physically moving the second module 110 in the direction 125 which is a direction away from the second node 120.

The modules 105 and 110 may be powered by various methods. For example, the modules 105 and 110 may be powered by the voltage sources 135 and 140, respectively. The first voltage source 135 may be included or disposed in the first module 105, while the second voltage source 140 may be included or disposed in the second module 110. The voltage sources 135 and 140 may be any suitable voltage sources such as, for example, battery sources, rechargeable voltage sources, solar-based power sources, and/or other types of voltage sources.

As another example, the modules 105 and 110 may be powered by voltages from the nodes 115 and 120, respectively. A first electrical conduit (e.g., cable or wire) 145 may be connected to a voltage input 150 of the first module 105 and to a voltage output 155 (if available) of the first node 115. Therefore, a voltage signal 160 from the first node 115 may transmit via the first electrical conduit 145 to the first module 105, and the voltage signal 160 will provide power to the first module 105. Other suitable methods and/or suitable features may be used to provide power to the modules 105 and 110.

Similarly, a second electrical conduit (e.g., cable or wire) 160 may be connected to a voltage input 165 of the second module 110 and to a voltage output 170 (if available) of the second node 120. Therefore, a voltage signal 175 from the second node 120 may transmit via the second electrical conduit 162 to the second module 110, and the voltage signal 175 will provide power to the second module 110.

In an embodiment of the invention, the first module 105 includes a first set of connectors 176 (i.e., a first connector set 176) that can electrically connect the first module 105 to the first node 115. For example, the first connector set 176 can include the connectors 176a, 176b, and 176c, although the first connector set 176 can include any suitable number of connectors.

Additionally or optionally, in an embodiment of the invention, the first module 105 includes a second set of connectors 177 (i.e., a second connector set 177) that can electrically connect the first module 105 to the first node 115. For example, the second connector set 177 can include the connectors 177a, 177b, and 177c, although the second connector set 177 can include any suitable number of connectors.

In an embodiment of the invention, the second module 110 includes a third set of connectors 178 (i.e., a third connector set 178) that can electrically connect the second module 110 to the second node 120. For example, the third connector set 178 can include the connectors 178a, 178b, and 178c, although the third connector set 178 can include any suitable number of connectors.

Additionally or optionally, in an embodiment of the invention, the second module 110 includes a fourth set of connectors 179 (i.e., a fourth connector set 179) that can electrically connect the second module 110 to the second node 120. For example, the fourth connector set 179 can include the connectors 179a, 179b, and 179c, although the fourth connector set 179 can include any suitable number of connectors.

The first node 115 includes a first set of signal ports 180 (i.e., a first signal ports set 180) that can output a first signal 181 of a first type from the first node 115. For example, the first signal 181 is a video signal from the first node 115 and is transmitted by the first node 115 through the ports set 180 in order to output the first signal 181 from the first node 115. As an example, the first signal ports set 180 can include the ports 180a, 180b, and 180c, although the first signal ports set 180 can include any suitable number of ports. For example, the first signal 181 can output from a single port 180 instead of the multiple ports 180a, 180b, and 180c. As a further example, if the port set 180 includes a plurality of ports 180 (e.g., ports 180a, 180b, and 180c, or ports 180a and 180b), then the first signal 181 can output from the plurality of ports 180 (e.g., ports 180a, 180b, and 180c, or ports 180a and 180b).

The first node 115 may also include a second set of signal ports 182 (i.e., a second signal ports set 182) that can output a second signal 183 of a second type from the first node 115. For example, the second signal 183 is an audio signal from the first node 115 and is transmitted by the first node 115 through the ports set 182 in order to output the second signal 183 from the first node 115. The type of the first signal 181 will typically differ from the type of the second signal 183. As an example, the second signal ports set 182 can include the ports 182a, 182b, and 182c, although the second signal ports set 182 can include any suitable number of ports. For example, the second signal 183 can output from a single port 183 instead of the multiple ports 182a, 182b, and 182c. As a further example, if the port set 182 includes a plurality of ports 182 (e.g., ports 182a, 182b, and 182c, or ports 182a and 182b), then the second signal 182 can output from the plurality of ports 182 (e.g., ports 182a, 182b, and 182c, or ports 182a and 182b).

Similarly, the second node 120 includes a third set of signal ports 184 (i.e., a third signal ports set 184) that can receive the first signal 181 of the first type from the first node 115. As an example, the third signal ports set 184 can include the ports 184a, 184b, and 184c, although the third signal ports set 184 can include any suitable number of ports. For example, the first signal 181 can output from a single port 184 instead of the multiple ports 184a, 184b, and 184c. As a further example, if the port set 184 includes a plurality of ports 184 (e.g., ports 184a, 184b, and 184c, or ports 184a and 184b), then the first signal 181 can output from the plurality of ports 184 (e.g., ports 184a, 184b, and 184c, or ports 184a and 184b).

The second node 120 may also include a fourth set of signal ports 185 (i.e., a fourth signal ports set 185) that can receive the second signal 183 of the second type from the first node 115. As an example, the fourth signal ports set 185 can include the ports 185a, 185b, and 185c, although the fourth signal ports set 185 can include any suitable number of ports. For example, the second signal 183 can output from a single port 185 instead of the multiple ports 185a, 185b, and 185c. As a further example, if the port set 185 includes a plurality of ports 185 (e.g., ports 185a, 185b, and 185c, or ports 185a and 185b), then the second signal 182 can output from the plurality of ports 185 (e.g., ports 185a, 185b, and 185c, or ports 185a and 185b).

In order to removably couple the first InDirect connect module 105 to the first node 115, the connectors 176 are removably inserted into and removably secured into the ports 180. For example, the connectors 176a, 176b, and 176c are removably inserted into and removably secured into the ports 180a, 180b, and 180c, respectively. Therefore, the ports 180a, 180b, and 180c (i.e., the ports set 180) are electrically coupled to and communicatively coupled to the connectors 176a, 176b, and 176c (i.e., the connectors 176), respectively. As a result, the first signal 181 can transmits from the ports 180 in the node 115 to the connectors 176 of the first module 105, and the first module 105 provides an indirect connect path of the first signal 181 from the node 115 to the wireless path 187. The wireless path 187 is air space or vacuum space.

Additionally or alternatively, in order to removably couple the first InDirect connect module 105 to the first node 115, the connectors 177 are removably inserted into and removably secured into the ports 182. For example, the connectors 177a, 177b, and 177c are removably inserted into and removably secured into the ports 182a, 182b, and 182c, respectively. Therefore, the ports 182a, 182b, and 182c (i.e., the ports set 182) are electrically coupled to and communicatively coupled to the connectors 177a, 177b, and 177c (i.e., the connectors 177), respectively. As a result, the second signal 183 can transmits from the ports 182 in the node 115 to the connectors 177 of the first module 105, and the first module 105 provides an indirect connect path of the second signal 183 from the first node 115 to the wireless path 187.

In order to removably couple the second InDirect connect module 110 to the second node 120, the connectors 178 are removably inserted into and removably secured into the ports 184. For example, the connectors 178a, 178b, and 178c are removably inserted into and removably secured into the ports 184a, 184b, and 184c, respectively. Therefore, the ports 184a, 184b, and 184c (i.e., the ports set 184) are electrically coupled to and communicatively coupled to the connectors 178a, 178b, and 178c (i.e., the connectors 178), respectively. As a result, the first signal 181 transmits from the ports 180 (e.g., ports 180a, 180b, and 180c) in the node 115 to the connectors 176 (e.g., connectors 176a, 176b, and 176c) of the first module 105, and the first signal 181 then transmits from the first module 105 via the wireless path 187 (e.g., air medium or vacuum medium) to the second module 110. After the second module 110 receives the first signal 181, the first signal 181 transmits from the connectors 178 (e.g., connectors 178a, 178b, and 178c) of the second module 110 to the ports 184 (e.g., ports 184a, 184b, and 184c) of the second node 120. The second node 120 then processes the first signal 181. For example, the second node 120 can display a video signal 181 into an image or video seen in a video input interface 195 and/or the second node 120 can output an audio signal 183 into an audio output or sound heard in an audio output interface 196. By way of example and not by way of limitation, the video output interface 195 is a visual screen or visual panel and the audio output interface is a speaker. Therefore, the second module 110 provides an indirect connect path of the first signal 181 from the wireless path 187 to the second node 120.

Additionally or alternatively, in order to removably couple the second InDirect connect module 110 to the second node 120, the connectors 179 are removably inserted into and removably secured into the ports 185. For example, the connectors 179a, 179b, and 179c are removably inserted into and removably secured into the ports 185a, 185b, and 185c, respectively. Therefore, the ports 185a, 185b, and 185c (i.e., the ports set 185) are electrically coupled to and communicatively coupled to the connectors 179a, 179b, and 179c (i.e., the connectors 179), respectively. As a result, the second signal 183 can transmits from the ports 182 in the node 115 to the connectors 177 of the first module 105, and the first module 105 transmits the second signal 183 via the wireless path 187. Therefore, the first module 105 provides an indirect connect path of the second signal 183 from the node 115 to the wireless path 187. The second module 110 receives the second signal 183 from the wireless path 187 and transmits the second signal 183 along the connectors 179 (e.g., connectors 179a, 179b, and 179c) of the second module 110 to the ports 185 (e.g., ports 185a, 185b, and 185c) in the second node 120. The second node 120 then processes the second signal 183 as similarly discussed above. Therefore, the second module 110 provides an indirect connect path of the second signal 183 from the wireless path 187 to the second node 120.

In an embodiment of the invention, the first module 190 includes a first wireless processing system 190 that is configured to transmit the first signal 181 and/or second signal 183 and the second module 192 includes a second wireless processing system 192 that is configured to receive and process the first signal 181 and/or second signal 183. The first wireless processing system 190 can also be configured to receive wireless signals transmitted from the second module 110 and the second wireless processing system 192 can also be configured to transmit wireless signals to the first module 105.

By way of example and not by way of limitation, the first consumer electronic device 115 can be a DVD player and the second consumer electronic device 120 can be a television. If the first module 105 is removably coupled to the first device 115 and the second module 110 is removably coupled to the second device 120, then the first module 105 can wirelessly transmit the first signal 181 and/or the second signal 183 to the second module 110 without the need to use cables or wires. Additionally, the first module 105 can be spaced apart from the second module 110 at a distance that is not constrained by any limited cable lengths. Furthermore, a consumer can now place a first consumer electronic device 115 (e.g., a DVD player) next to himself/herself and a second consumer electronic device 120 (e.g., a television or any electronic device that generates an audio output and/or a video output) at a further distance and can conveniently take advantage of the wireless signal transmissions between the first module 105 and the second module 110, and can also advantageously access the first consumer electronic device 115 locally and conveniently while the second consumer electronic device 120 is spaced apart from the consumer. Therefore, the consumer is no longer required to get up and move in order to change a movie on a DVD that was previously disposed adjacent to a television in current systems. Therefore, the modules 105 and 110 permit the consumer to rearrange the consumer electronic devices in his/her living room in configurations or layouts that were not previously possible.

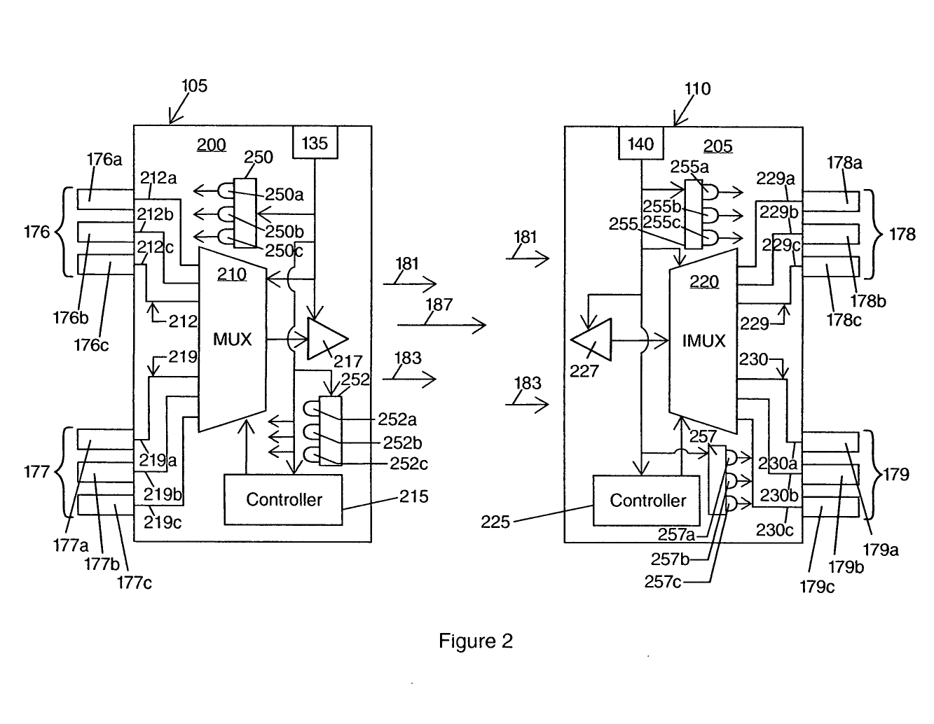

FIG. 2 is a block diagram of a first InDirect connect module 105 and a second InDirect connect module 110, in accordance with an embodiment of the invention.

The components and circuitry in the first module 105 and second module 105b are provided by the baseline technology 200 and 205, respectively. The baseline technologies 200 and 205 are, for example, without limitations, circuit boards with components, wirings, traces, semiconductor elements, and/or other electrical/electronic elements. Additionally or alternatively, the baseline technologies 200 and 205 can be programmable logic devices (PLDs) such as, for example, field programmable gate arrays (FPGAs) or PLDs, in combination with other electrical/electronic elements. Additionally or alternatively, the baseline technologies 200 and 205 can be ASICs (application specific integrated circuits), ASICs in combination with other electrical/electronic elements, nano-technology based elements, or nano-technology based elements in combination with other electrical/electronic elements, or other suitable technologies that may be developed as knowledge advances. For ease of discussion, known electrical/electronic elements such as, for example, conductors, relays, switches, transistors, and/or other elements are not necessarily shown in FIG. 2.

In an embodiment, the module 105 includes a multiplexer 210, a controller 215, and a transceiver 217. The multiplexer 210 receives the first signal 181 along the signal paths 212 (e.g., the signal paths 212a, 212b, and 212c). The controller 215 is coupled to the multiplexer 210 and will control the multiplexing function of the multiplexer 210 so that the multiplexer 210 will output the components of the first signal 181 (from lines 212a-212c) in a multiplexed manner as selected by the controller 215. The multiplexed signal 181 is then received by the transceiver 217 which then transmits the signal 181 toward the wireless path 187.

In an embodiment, the multiplexer 210 receives the second signal 183 along the signal paths 219 (e.g., the signal paths 219a, 219b, and 219c). The controller 215 is coupled to the multiplexer 210 and will control the multiplexing function of the multiplexer 210 so that the multiplexer 210 will output the components of the second signal 183 (from lines 219a-219c) in a multiplexed manner as selected by the controller 215. The multiplexed signal 183 is then received by the transceiver 217 which then transmits the signal 183 toward the wireless path 187.

In the case where the multiplexer 210 receives both of the signals 181 and 183, the controller 215 will control the multiplexing function of the multiplexer 210 so that the multiplexer 210 will output the components of the first signal 181 (from lines 212a-212c) and the components of the second signal 183 (from lines 219a-219c) in a multiplexed manner as selected by the controller 215. In this example, the transceiver 217 then transmits the signal 181 and the signal 183 toward the wireless path 187.

In an embodiment, the module 110 includes an inverse multiplexer 220, a controller 225, and a transceiver 227. The transceiver 227 receives the signal 181. The inverse multiplexer 220 receives the first signal 181 from the multiplexer 220 and transmits the components of the signal 181 along the signal paths 229 (e.g., the signal paths 229a, 229b, and 229c). The controller 225 is coupled to the inverse multiplexer 220 and will control the multiplexing function of the inverse multiplexer 220 so that the inverse multiplexer 220 will output the components of the first signal 181 via lines 229a-229c in a multiplexed manner as selected by the controller 225. The inverse multiplexed signal 181 is then received by respective conductors 178. For example, the components of the inverse multiplexed signal 181 along the paths 229a, 229b, and 229c is received by the conductors 178a, 178b, and 178c, respectively.

In an embodiment, the transceiver 227 receives the signal 183. The inverse multiplexer 220 receives the second signal 183 and transmits the components of the signal 183 along the signal paths 230 (e.g., the signal paths 230a, 230b, and 230c). The controller 225 is coupled to the inverse multiplexer 220 and will control the multiplexing function of the inverse multiplexer 220 so that the inverse multiplexer 220 will output the components of the second signal 183 via lines 230a-230c in a multiplexed manner as selected by the controller 225. The inverse multiplexed signal 183 is then received by respective conductors 179. For example, the components of the inverse multiplexed signal 183 along the paths 230a, 230b, and 230c is received by the conductors 179a, 179b, and 179c, respectively

In the case where the transceiver 227 receives both of the signals 181 and 183, the controller 225 will control the inverse multiplexing function of the inverse multiplexer 220 so that the inverse multiplexer 220 will output the components of the first signal 181 via lines 229a-229c and the components of the second signal 183 via lines 230a-230c in an inverse multiplexed manner as selected by the controller 225. In this example, the inverse multiplexer 220 will inverse multiplex the signal 181 and the signal 183 and output the components of the first signal 181 along the lines 229a-229c and output the components of the second signal 183 along the lines 230a-230c.

In another embodiment, the transceiver 217 is embodied as a transmitter 217 and the transceiver 227 is embodied as a receiver 227. In yet another embodiment, the transceivers 217 and 227 can be embodied as separate transmitter and receiver components. Controllers, transceivers, multiplexers, and inverse multiplexers are commercially available from various vendors.

In another embodiment of the invention, the first module 105 includes a single conductor 176 (instead of multiple conductors 176a, 176b, and 176c) and the single conductor 176 is coupled to the multiplexer 210 by a single line (conductive path) 212 (instead of multiple conductive paths 212a, 212b, and 212c). The first signal 181 transmits along the single conductor 176 and single line 212 and then transmits to the multiplexer 210. In this embodiment of the invention, the first module 105 includes a single conductor 177 (instead of multiple conductors 177a, 177b, and 177c) and the single conductor 177 is coupled to the multiplexer 210 by a single line (conductive path) 219 (instead of multiple conductive paths 219a, 219b, and 219c). The second signal 183 transmits along the single conductor 177 and single line 219 and then transmits to the multiplexer 210.

In another embodiment of the invention, the second module 110 includes a single conductor 178 (instead of multiple conductors 178a, 178b, and 178c) and the single conductor 178 is coupled to the inverse multiplexer 220 by a single line (conductive path) 229 (instead of multiple conductive paths 229a, 229b, and 229c). The first signal 181 transmits from the inverse multiplexer 220 to the single line 220 and single conductor 178. In this embodiment of the invention, the second module 110 includes a single conductor 179 (instead of multiple conductors 179a, 179b, and 179c) and the single conductor 179 is coupled to the inverse multiplexer 220 by a single line (conductive path) 230 instead of multiple conductive paths 230a, 230b, and 230c. The second signal 183 transmits from the inverse multiplexer 220 to the single line 230 and single conductor 179.

In an embodiment, the modules 105 and 107 can replace the High-Definition Multimedia Interface (HDMI) cables, Ethernet cables, and/or other types of cables.

In another embodiment of the invention, the first module 105 may include a first LED set 250 and/or a second LED set 252. For example, the first LED set 250 includes a red LED 250a for generating red light, a green LED 250b for generating green light, and a blue LED 250c for generating blue light. The red light, green light, and blue light are directed to the connectors 176a, 176b, and 176c, respectively, by, for example, placing the LEDs 250a-250c adjacent to the connectors 176a-176c, respectively, or by use of a waveguide for guiding light from the LEDs 250a-2050c to a first area adjacent to the connectors 176a-176c on the first module 105.

As another example, the second LED set 252 includes a white LED 252a for generating white light, a yellow LED 252b for generating yellow light, and an orange LED 252c for generating orange light. The white light, yellow light, and orange light are directed to the connectors 177a, 177b, and 177c, respectively, by, for example, placing the LEDs 252a-252c adjacent to the connectors 177a-177c, respectively, or by use of a second waveguide for guiding light from the LEDs 252a-252c to the second area adjacent to the connectors 177a-177c on the first module 105.

The components in the module 105 (e.g., multiplexer 210, controller 215, transceiver 217, and LED sets 250 and 252) may be powered by the voltage source 135.

In another embodiment of the invention, the second module 110 includes a third LED set 255 and/or a fourth LED set 257. For example, the third LED set 255 includes a red LED 255a for generating red light, a green LED 255b for generating green light, and a blue LED 255c for generating blue light. The red light, green light, and blue light are directed to the connectors 178a, 178b, and 178c, respectively, by, for example, placing the LEDs 255a-255c adjacent to the connectors 178a-178c, respectively, or by use of a third waveguide for guiding light from the LEDs 255a-255c to the third area adjacent to the connectors 178a-178c on the second module 110.

As another example, the fourth LED set 257 includes a white LED 257a for generating white light, a yellow LED 257b for generating yellow light, and an orange LED 257c for generating orange light. The white light, yellow light, and orange light are directed to the connectors 179a, 179b, and 179c, respectively, by, for example, placing the LEDs 257a-257c adjacent to the connectors 179a-179c, respectively, or by use of a fourth waveguide for guiding light from the LEDs 257a-257c to the fourth area adjacent to the connectors 179a-179c on the second module 110.

The components in the module 110 (e.g., inverse multiplexer 220, controller 225, transceiver 227, and LED sets 255 and 257) may be powered by the voltage source 140.

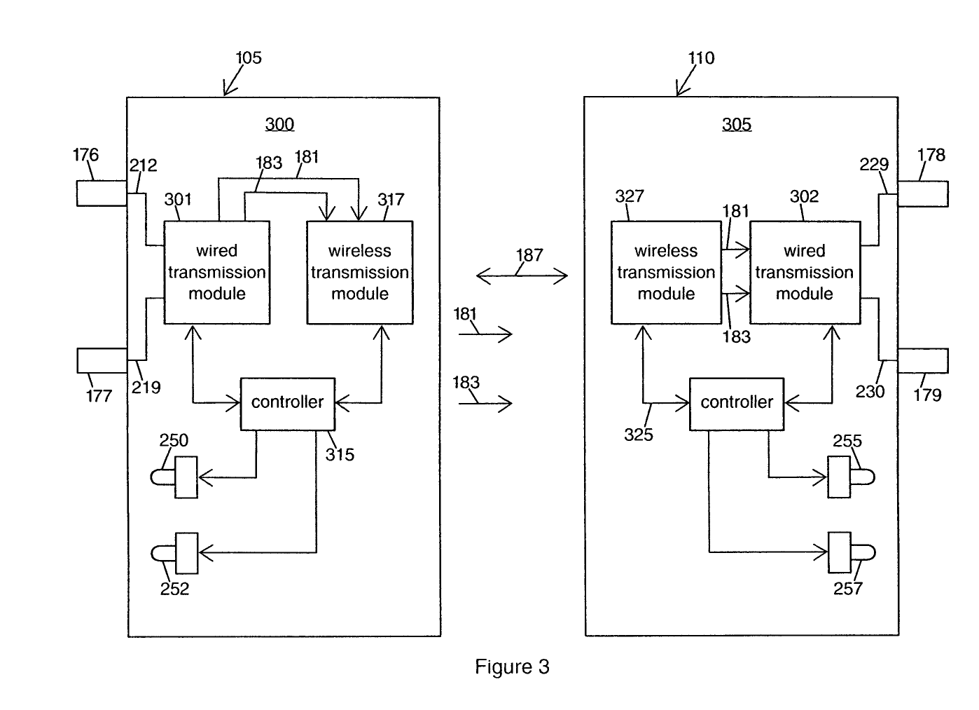

FIG. 3 is a block diagram of a first InDirect connect module 105 and a second InDirect connect module 110, in accordance with another embodiment of the invention. The components and circuitry in the first module 105 and second module 115 are provided by the baseline technologies 300 and 305, respectively. The baseline technologies 300 and 305 are, for example, without limitations, circuit boards with components, wirings, traces, semiconductor elements, and/or other electrical/electronic elements. Additionally or alternatively, the baseline technologies 300 and 305 can be programmable logic devices (PLDs) such as, for example, field programmable gate arrays (FPGAs) or PLDs, in combination with other electrical/electronic elements. Additionally or alternatively, the baseline technologies 300 and 305 can be ASICs, ASICs in combination with other electrical/electronic elements, nano-technology based elements, or nano-technology based elements in combination with other electrical/electronic elements, or other suitable technologies that may be developed as knowledge advances. For ease of discussion, known electrical/electronic elements such as, for example, conductors, relays, switches, transistors, and/or other elements are not necessarily shown in FIG. 3.

As similarly discussed above, the module 105 (FIG. 1) produces video signal 181 and audio signal 183 and transmits these video signal 181 and audio signal 183 as wired signals that are received via the conductors 176 and 177, respectively. As discussed above, the conductors 176 and 177 are removably coupled to the ports 180 and 182, respectively, of the node 115. The module 105 includes a first wired transmission module 301, a first wireless transmission module 315, and a first controller 315. The wired transmission module 301 transmits the video data 181 and audio data 183 from the conductive path 212 and 219, respectively, to the wireless transmission module 317. The wireless transmission module 317 performs wireless transmission processing of the signals 181 and 183 by, for example, wireless transmission, wireless reception, modulation, and demodulation of wireless signals. The module 317 processes the signals 181 and 183 received from the module 301 and transmits these processed signals 181 and 183 to the module 110 by wireless transmission of the signals 181 and 183. Time division multiplexing or frequency division multiplexing may be used by the wireless transmission modules 317 and 327 in the wireless transmission of the signals 181 and 183. The module 317 includes, for example, at least some of the following components such as an antenna, a radio frequency circuit, and a baseband processing circuit. The module 317 may be configured to use any suitable type of wireless transmission method as known to those skilled in the relevant art(s) such as, for example, transmission of electric waves and media access control in which the wireless signal radio frequency band or time is reserved and the video and audio signals are transmitted and received in the reserved radio frequency band or time. As a further example, each of the wireless transmission modules 317 and 327 can be a 5.8 GHz wireless transceiver (or 5.8 GHz wireless transmitter and wireless receiver).

The controller 315 controls at least some of the functions of the modules 301 and 317. The controller 315 also controls the operation of the LEDs 250 and 252 as similarly discussed above with the operation of the controller 215 in FIG. 2.

The module 110 includes a second wired transmission module 302, a second wireless transmission module 327 and a second controller 325. The wireless transmission module 327 receives the video signal 181 and audio signal 183 that are wirelessly transmitted from the module 105 to the module 110. The module 327 processes and transmits the signals 181 and 183 to the module 302. The module 327 includes, for example, at least some of the following components such as an antenna, a radio frequency circuit, and a baseband processing circuit. The module 327 may be configured to use any suitable type of wireless transmission method as known to those skilled in the relevant art(s) such as, for example, transmission of electric waves and media access control in which the wireless signal radio frequency band or time is reserved and the video and audio signals are transmitted and received in the reserved radio frequency band or time. The wired transmission module 302 then transmits the video signal 181 via the conductive path 229 to the conductor 178 and transmits the audio signal 183 via the conductive path 230 to the conductor 179. As discussed above, the conductors 178 and 179 are removably coupled to ports 184 and 185, respectively, of the second node 120. The node 120 can then output the video signal 181 via the video interface 195 (FIG. 1) and output the audio signal 183 via the audio interface 196 of the node 120.

The controller 325 controls at least some of the functions of the modules 302 and 327. The controller 325 also controls the operation of the LEDs 255 and 257 as similarly discussed above with the operation of the controller 215 in FIG. 2.

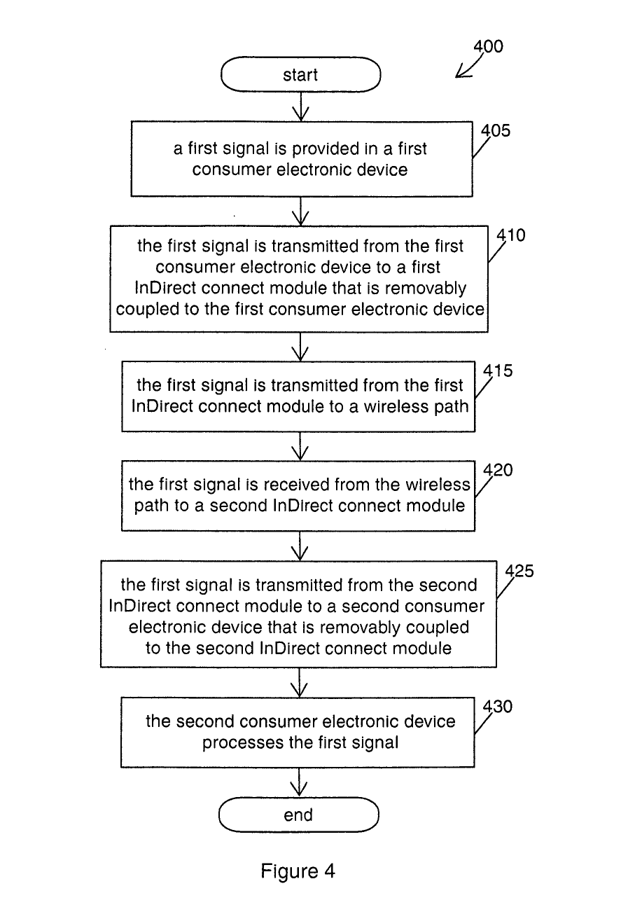

FIG. 4 is a flow diagram of a method 400 for an InDirect communication, in accordance with an embodiment of the invention. In block 405, a first signal is provided in a first consumer electronic device. As similarly discussed above, the first signal can be, by way of example and not by way of limitation, a video signal or an audio signal or a video signal with an associated audio signal. A second signal can also be provided in the first consumer electronic device. For example, the second signal could be of a type that differs from the type of the first signal. As a further example, the first signal can be a video signal while the second signal can be an audio signal.

In block 410, the first signal is transmitted from the first consumer electronic device to a first InDirect connect module that is removably coupled to the first consumer electronic device.

In block 415, the first signal is transmitted from the first InDirect connect module to a wireless path such as, by way of example and not by way of limitation, air or vacuum.

In block 420, the first signal is received from the wireless path to a second InDirect connect module.

In block 425, the first signal is transmitted from the second InDirect connect module to a second consumer electronic device that is removably coupled to the second InDirect connect module.

In block 430, the second consumer electronic device processes the first signal. As mentioned above, a second signal and/or one or more additional signals can be transmitted from the first InDirect connect module to the second InDirect connect module.

In summary, in one embodiment of the invention, an apparatus for an InDirect connect includes: a first InDirect connect module configured for removable attachment to a first consumer electronic device, and a second InDirect connect module configured for removable attachment to a second consumer electronic device, the first InDirect connect module including a first wireless system for transmitting a first signal and the second InDirect connect module including a second wireless system for receiving the first signal.

In another of the invention, an apparatus for an InDirect connect includes: a first InDirect connect means for removable attachment to a first consumer electronic device, and a second InDirect connect means for removable attachment to a second consumer electronic device, the first InDirect connect means including a first wireless processing means for transmitting a first signal and the second InDirect connect means including a second wireless processing means for receiving the first signal.

In yet another embodiment of the invention, a method for an InDirect connect communication includes: providing a first signal in a first consumer electronic device; transmitting the first signal from the first consumer electronic device to a first InDirect connect module that is removably coupled to the first consumer electronic device; transmitting the first signal from the first InDirect connect module to a wireless path; receiving the first signal from the wireless path to a second InDirect connect module; and transmitting the first signal from the second InDirect connect module to a second consumer electronic device that is removably coupled to the second InDirect connect module.

Those skilled in the art will realize that based on the discussion herein, other suitable materials or other combination of suitable materials can be used for the components in the system 100. Those skilled in the art will also realize, after reading the discussion herein, that the assembly, manufacture, and/or construction of the components of the system 100 may be selectively varied based on cost, ease of manufacturing, or/and other considerations. Additionally, the parts or components in the system 100 can be suitably varied or substituted with other parts or components, as electrical/electronic components technologies and mechanical technologies improve in the future.

It is also understood that other systems according to an embodiment of the invention can have other forms and can have other different components that are arranged in other ways or in other orientations.

Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus comprising:
a first InDirect connect module configured for removable attachment to a first consumer electronic device; and
a second InDirect connect module configured for removable attachment to a second consumer electronic device, the first InDirect connect module including a first wireless system for transmitting a signal and the second InDirect connect module including a second wireless system for receiving the signal.

2. The apparatus of claim 1 wherein the second consumer electronic device is configured to generate an audio signal in response to the signal.

3. The apparatus of claim 1 wherein the second consumer electronic device is configured to generate a video signal in response to the signal.

4. The apparatus of claim 1, wherein the first InDirect connect module comprises a first connector; wherein the second InDirect connect module comprises a second connector; wherein the first consumer electronic device comprises a first port; wherein the second consumer electronic device comprises a second port;
wherein the first connector is removably coupled to the first port; and wherein the second connector is removably coupled to the second port.

5. An apparatus comprising:
a first InDirect connect means for removable attachment to a first consumer electronic device; and
a second InDirect connect means for removable attachment to a second consumer electronic device, the first InDirect connect means including a first wireless processing means for transmitting a signal and the second InDirect connect means including a second wireless processing means for receiving the signal.

6. The apparatus of claim 5 wherein the second consumer electronic device is configured to generate an audio signal in response to the signal.

7. The apparatus of claim 5 wherein the second consumer electronic device is configured to generate a video signal in response to the signal.

8. The apparatus of claim 5, wherein the first InDirect connect means comprises a first connector; wherein the second InDirect connect means comprises a second connector; wherein the first consumer electronic device comprises a first port; wherein the second consumer electronic device comprises a second port;
wherein the first connector is removably coupled to the first port; and wherein the second connector is removably coupled to the second port.

9. A method comprising:
providing a signal in a first consumer electronic device;
transmitting the signal from the first consumer electronic device to a first InDirect connect module that is removably coupled to the first consumer electronic device;
transmitting the signal from the first InDirect connect module to a wireless path;
receiving the signal from the wireless path to a second InDirect connect module; and
transmitting the signal from the second InDirect connect module to a second consumer electronic device that is removably coupled to the second InDirect connect module.

10. The method of claim 9 further comprising: generating an audio signal from the second consumer device in response to the signal.

11. The method of claim 9 generating a video signal from the second consumer device in response to the signal.

12. The method of claim 1, wherein the first InDirect connect module comprises a first connector; wherein the second InDirect connect module comprises a second connector; wherein the first consumer electronic device comprises a first port; wherein the second consumer electronic device comprises a second port;
wherein the method of claim 1 further comprises:
removably coupling the first connector to the first port; and removably coupling the second connector to the second port.
